(19) United States
(12) Patent Application Publication
(10) Pub. No.: US 2018/0137126 A1
(43) Pub. Date: May 17, 2018

(54) SYSTEM AND METHOD FOR IDENTIFYING INFLUENTIAL ENTITIES DEPICTED IN MULTIMEDIA CONTENT

(71) Applicant: Cortica, Ltd., Tel Aviv (IL)

(72) Inventors: Igal RAICHELGAUZ, Tel Aviv (IL); Karina ODINAEV, Tel Aviv (IL); Yehoshua Y. ZEEVI, Haifa (IL)

(73) Assignee: Cortica, Ltd., TEL AVIV (IL)

(21) Appl. No.: 15/813,453

(22) Filed: Nov. 15, 2017

Related U.S. Application Data
(63) Continuation-in-part of application No. 13/770,603, filed on Feb. 19, 2013.
Application No. 13/770,603 is a continuation-in-part of application No. 13/624,397, filed on Sep. 21, 2012, now Pat. No. 9,191,626.
Application No. 13/624,397 is a continuation-in-part of application No. 13/344,400, filed on Jan. 5, 2012, now Pat. No. 8,959,037.
Application No. 13/344,400 is a continuation of application No. 12/434,221, filed on May 1, 2009, now Pat. No. 8,112,376.
Application No. 13/624,397 is a continuation-in-part of application No. 12/195,863, filed on Aug. 21, 2008, now Pat. No. 8,326,775.
Application No. 12/195,863 is a continuation-in-part of application No. 12/084,150, filed on Apr. 7, 2009, now Pat. No. 8,655,801.
Application No. 13/624,397 is a continuation-in-part of application No. 12/084,150, filed on Apr. 7, 2009, now Pat. No. 8,655,801.
(60) Provisional application No. 62/422,624, filed on Nov. 16, 2016.

(30) Foreign Application Priority Data
Oct. 26, 2005 (IL) 171577
Jan. 29, 2006 (IL) 173409
Aug. 21, 2007 (IL) 185414

(51) Int. Cl. G06F 17/30; H04N 21/81; H04N 21/466; H04N 21/2668; H04N 21/258; H04N 7/173; H04H 20/10; H04H 60/66; H04H 60/56; H04H 60/46; H04H 60/37; H04H 20/26; H04L 29/08

(52) U.S. Cl. CPC G06F 17/30056; H04N 21/8106; H04N 21/466; H04N 21/2668; H04N 21/25891; H04N 7/17318; H04L 67/10; H04H 60/66; H04H 60/56; H04H 60/46; H04H 60/37; H04H 20/26; H04H 20/103

(57) ABSTRACT

A system and method for identifying influential entities depicted in multimedia content. The method includes determining, for each of a plurality of social linking graphs, a number of related entities, wherein each related entity has a social linking score above a first predetermined threshold, wherein each social linking score is generated based on at least one context of at least one multimedia content element (MMCE), and wherein each context is determined based on signatures generated for the at least one MMCE; and identifying, based on the determined number of related entities, at least one influential entity, wherein each influential entity is associated with one of the social linking graphs for which the determined number of related entities is above a second predetermined threshold.

### CROSS-REFERENCE TO RELATED APPLICATIONS

This application claims the benefit of U.S. Provisional Application No. 62/422,624 filed on Nov. 16, 2016. This application is also a continuation-in-part (CIP) of U.S. patent application Ser. No. 13/770,603 filed on Feb. 19, 2013, now pending, which is a CIP of U.S. patent application Ser. No. 13/624,397 filed on Sep. 21, 2012, now U.S. Pat. No. 9,191,626. The Ser. No. 13/624,397 application is a CIP of:

(a) U.S. patent application Ser. No. 13/344,400 filed on Jan. 5, 2012, now U.S. Pat. No. 8,959,037, which is a continuation of U.S. patent application Ser. No. 12/434,221 filed on May 1, 2009, now U.S. Pat. No. 8,112,376;

(b) U.S. patent application Ser. No. 12/195,863 filed on Aug. 21, 2008, now U.S. Pat. No. 8,326,775, which claims priority under 35 USC 119 from Israeli Application No. 185414, filed on Aug. 21, 2007, and which is also a CIP of the below-referenced U.S. patent application Ser. No. 12/084,150; and

(c) U.S. patent application Ser. No. 12/084,150 having a filing date of Apr. 7, 2009, now U.S. Pat. No. 8,655,801, which is the National Stage of International Application No. PCT/IL2006/001235, filed on Oct. 26, 2006, which claims foreign priority from Israeli Application No. 171577 filed on Oct. 26, 2005, and Israeli Application No. 173409 filed on Jan. 29, 2006.

All of the applications referenced above are herein incorporated by reference.

### TECHNICAL FIELD

The present disclosure relates generally to contextual analysis of multimedia content elements, and more specifically to determining influential entities depicted in multimedia content based on the contextual analysis of multimedia content.

### BACKGROUND

A primary goal of advertising is determining the most efficient and effective population to market a good or service to. Determining such an audience in the age of Internet commerce and social media is increasingly essential in a successful advertising campaign. However, with the rise of social networks, the Internet has become inundated with uploaded images, videos, and other content associated with individuals, making it difficult to identify persons most suited to a particular marketing campaign, as well as to identify relationships between various identified persons. Correctly identifying an influential individual within a social group can be a valuable asset for successful advertising.

One method of identifying individuals and relationships between various individuals include tagging persons depicted within multimedia content. Some people manually tag multimedia content in order to indicate the persons shown in images and videos in an effort to assist those seeking content featuring certain persons. The tags may be textual or include other identifiers in metadata of the multimedia content, thereby associating the textual identifiers with the multimedia content. Users may subsequently search for multimedia content elements with respect to tags by providing queries indicating desired subject matter. Tags therefore make it easier for users to find content related to a particular topic, and further allow for identifying individuals that are prevalent or otherwise more likely to influence on many other users.

A popular textual tag is the hashtag. A hashtag is a type of label typically used on social networking websites, chats, forums, microblogging services, and the like. Users create and use hashtags by placing the hash character (or number sign) # in front of a word or unspaced phrase, either in the main text of a message associated with content, or at the end. Searching for that hashtag will then present each message and, consequently, each multimedia content element, that has been tagged with it.

Accurate and complete listings of hashtags can increase the likelihood of a successful search for a certain multimedia content. Existing solutions for tagging typically rely on user inputs to provide identifications of subject matter. However, such manual solutions may result in inaccurate or incomplete tagging. Further, although some automatic tagging solutions exist, such solutions face challenges in efficiently and accurately identifying subject matter of multimedia content, including individuals presented within the multimedia content. Moreover, such solutions typically only recognize superficial expressions of subject matter in multimedia content and, therefore, fail to account for context in tagging multimedia content.

Additionally, tagging often fails to indicate the relationship between subjects within one or multiple multimedia content items. For example, a set of images showing two individuals may appear on a user profile of a social media account, but the social media platform may be unaware of the relationship between the two individuals. Further, it may be difficult to visualize the relationship among a larger group of individuals based on multimedia content items when relying on manual tagging to identify subjects within the multimedia content item.

It would therefore be advantageous to provide a solution that would overcome the challenges noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “some embodiments” may be used herein to refer to a single embodiment or multiple embodiments of the disclosure.

Certain embodiments disclosed herein include a method for identifying influential entities depicted in multimedia content. The method comprises: determining, for each of a plurality of social linking graphs, a number of related entities, wherein each related entity has a social linking score above a first predetermined threshold, wherein each social linking score is generated based on at least one context of at least one multimedia content element (MMCE), and wherein each context is determined based on signatures generated for the at least one MMCE; and identifying, based on the determined number of related entities, at least one influential entity, wherein each influential entity is associated with one of the social linking graphs for which the determined number of related entities is above a second predetermined threshold.

Certain embodiments disclosed herein also include a non-transitory computer readable medium having stored thereon instructions for causing a processing circuitry to perform a process, the process comprising: determining, for each of a plurality of social linking graphs, a number of related entities, wherein each related entity has a social linking score above a first predetermined threshold, wherein each social linking score is generated based on at least one context of at least one multimedia content element (MMCE), and wherein each context is determined based on signatures generated for the at least one MMCE; and identifying, based on the determined number of related entities, at least one influential entity, wherein each influential entity is associated with one of the social linking graphs for which the determined number of related entities is above a second predetermined threshold.

Certain embodiments disclosed herein also include a system for determining a social relativeness between at least two entities depicted in at least one multimedia content element (MMCE). The system comprises: a processing circuitry; and a memory, the memory containing instructions that, when executed by the processing circuitry, configure the system to: determine, for each of a plurality of social linking graphs, a number of related entities, wherein each related entity has a social linking score above a first predetermined threshold, wherein each social linking score is generated based on at least one context of at least one multimedia content element (MMCE), and wherein each context is determined based on signatures generated for the at least one MMCE; identify, based on the determined number of related entities, at least one influential entity, wherein each influential entity is associated with one of the social linking graphs for which the determined number of related entities is above a second predetermined threshold.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is an example network diagram utilized to describe the various disclosed embodiments

FIG. 2 is an example diagram of a Deep Content Classification system for creating concepts according to an embodiment.

FIG. 3 is a block diagram depicting the basic flow of information in a signature generator system.

FIG. 4 is a diagram showing the flow of patches generation, response vector generation, and signature generation in a large-scale speech-to-text system.

FIG. 5 is a flowchart of a method for generating social linking scores for persons shown in multimedia content elements according to an embodiment.

FIG. 6 is a flowchart illustrating a method of analyzing an MMCE according to an embodiment.

FIG. 7 is a flowchart illustrating a method of generating a social linking score in an embodiment.

FIG. 8 is an example diagram of a social linking graph in an embodiment.

FIG. 9 is a flowchart illustrating a method of determining an influential entity based on a social linking graph in an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for identifying influential entities depicted in multimedia content elements. Signatures are generated for each multimedia content element. Based on the generated signatures, one or more individuals shown in each multimedia content element are identified.

One or more contexts are determined for each multimedia content element based on the generated signatures. Based on the contexts and associated metadata, a social linking score is generated for each person shown in the multimedia content element. The generated social linking score may be based on, for example, an amount of multimedia content elements in which a person is shown, a time stamp associated with a first appearance in a multimedia content element, a time stamp associated with a last appearance in a multimedia content element, physical interaction with the user in the multimedia content elements (e.g., kissing, hugging, shaking hands, etc.), a location coordinate identified based on the analysis, other persons identified therein, tags, comments, a combination thereof, and the like. In an embodiment, a social linking graph is generated based on the generated scores.

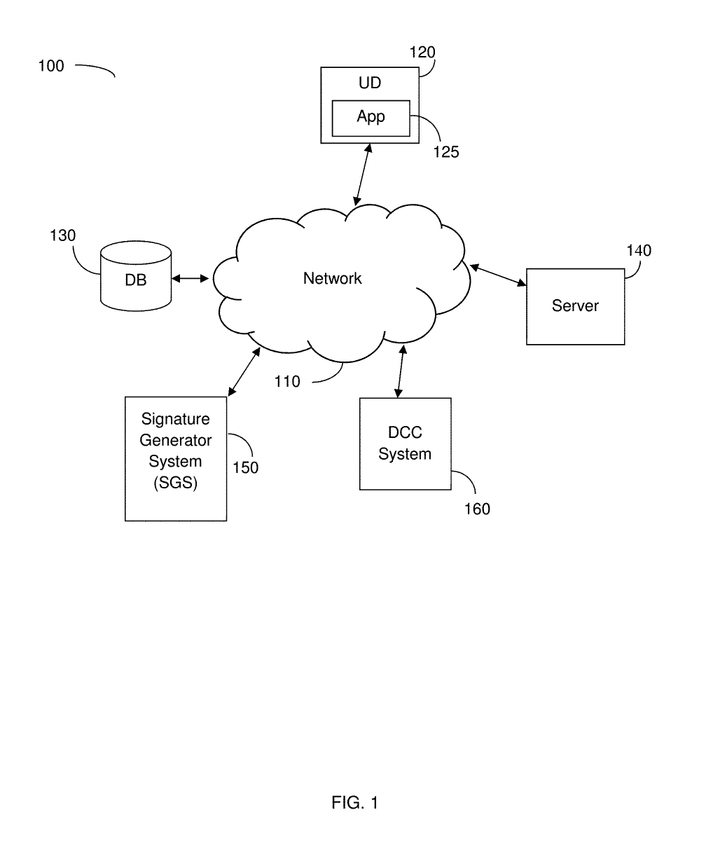

FIG. 1 is an example network diagram 100 utilized for describing certain embodiments disclosed herein. A user device (UD) 120, a database (DB) 130, a server 140, a signature generator system (SGS) 150, and a Deep Content Classification (DCC) system 160 are communicatively connected via a network 110. The network 110 may be, but is not limited to, a local area network (LAN), a wide area network (WAN), a metro area network (MAN), the world wide web (WWW), the Internet, a wired network, a wireless network, and the like, as well as any combination thereof.

The user device 120 may be, but is not limited to, a personal computer (PC), a personal digital assistant (PDA), a mobile phone, a smart phone, a tablet computer, a wearable computing device, and other kinds of wired and mobile devices capable of capturing, uploading, browsing, viewing, listening, filtering, and managing multimedia content elements as further discussed herein below. The user device 120 may have installed thereon an application 125 such as, but not limited to, a web browser. The application 125 may be downloaded from an application repository, such as the Apple® AppStore®, Google Play®, or any repositories hosting software applications. The application 125 may be pre-installed in the user device 120.

The application 125 may be configured to store and access multimedia content elements within the user device, such as on an internal storage (not shown), as well as to access multimedia content elements from an external source, such as the database 130 or a social media website. For example, the application 125 may be a web browser through which a user of the user device 120 accesses a social media website and uploads multimedia content elements thereto.

The database 130 is configured to store MMCEs, signatures generated based on MMCEs, concepts that have been generated based on signatures, contexts that have been determined based on concepts, social linking scores, social linking graphs, or a combination thereof. The database 130 is accessible by the server 140, either via the network 110 (as shown in FIG. 1) or directly (not shown).

The server 140 is configured to communicate with the user device 120 via the network 110. The server 140 may include a processing circuitry and a memory (both not shown). The processing circuitry may be realized as one or more hardware logic components and circuits. For example, and without limitation, illustrative types of hardware logic components that can be used include field programmable gate arrays (FPGAs), application-specific integrated circuits (ASICs), application-specific standard products (ASSPs), system-on-a-chip systems (SOCs), general-purpose microprocessors, microcontrollers, digital signal processors (DSPs), and the like, or any other hardware logic components that can perform calculations or other manipulations of information.

In an embodiment, the memory is configured to store software. Software shall be construed broadly to mean any type of instructions, whether referred to as software, firmware, middleware, microcode, hardware description language, or otherwise. Instructions may include code (e.g., in source code format, binary code format, executable code format, or any other suitable format of code). The instructions, when executed by the one or more processors, cause the processing circuitry to perform the various processes described herein. Specifically, the instructions, when executed, configure the processing circuitry to determine social linking scores, as discussed further herein below.

In an embodiment, the server 140 is configured to access to a plurality of multimedia content elements (MMCEs), for example, from the user device 120 via the application 125 installed thereon, that are associated with a user of the user device 120. The MMCEs may be, for example, an image, a graphic, a video stream, a video clip, an audio stream, an audio clip, a video frame, a photograph, and/or combinations thereof and portions thereof. The MMCEs may be captured by a sensor (not shown) of the user device 120. The sensor may be, for example, a still camera, a video camera, a combination thereof, etc. Alternatively, the MMCEs may be accessed from a web source over the network 110, such as a social media website, or from the database 140.

The server 140 is configured to analyze the plurality of MMCEs and generate signatures based on each of the MMCEs. In an embodiment, the MMCEs are sent to the SGS 150 over the network 110. In an embodiment, the SGS 150 is configured to generate at least one signature for each MMCE, based on content of the received MMCE as further described herein. The signatures may be robust to noise and distortion as discussed below.

According to a further embodiment, the server 140 may further be configured to identify metadata associated with each of the MMCEs. The metadata may include, for example, a time stamp of the capturing of the MMCE, the device used for the capturing, a location pointer, tags or comments, and the like.

The Deep Content Classification (DCC) system 160 is configured to identify at least one concept based on the generated signatures. Each concept is a collection of signatures representing MMCEs and metadata describing the concept, and acts as an abstract description of the content to which the signature was generated. As a non-limiting example, a ‘Superman concept’ is a signature-reduced cluster of signatures describing elements (such as multimedia elements) related to, e.g., a Superman cartoon: a set of metadata representing proving textual representation of the Superman concept. As another example, metadata of a concept represented by the signature generated for a picture showing a bouquet of red roses is “flowers.” As yet another example, metadata of a concept represented by the signature generated for a picture showing a bouquet of wilted roses is “wilted flowers.”

The server 140 is further configured to determine one or more contexts for each MMCE in which a person is shown. Each context is determined by correlating among the signatures, the concepts, or both. A strong context may be determined, e.g., when there are at least a threshold number of concepts that satisfy the same predefined condition. As a non-limiting example, by correlating a signature of a person in a baseball uniform with a signature of a baseball stadium, a context representing a “baseball player” may be determined. Correlations among the concepts of multimedia content elements can be achieved using probabilistic models by, e.g., identifying a ratio between signatures' sizes, a spatial location of each signature, and the like. Determining contexts for multimedia content elements is described further in the above-referenced U.S. patent application Ser. No. 13/770,603, assigned to the common assignee, which is hereby incorporated by reference. It should be noted that using signatures for determining the context ensures more accurate reorganization of multimedia content than, for example, when using metadata.

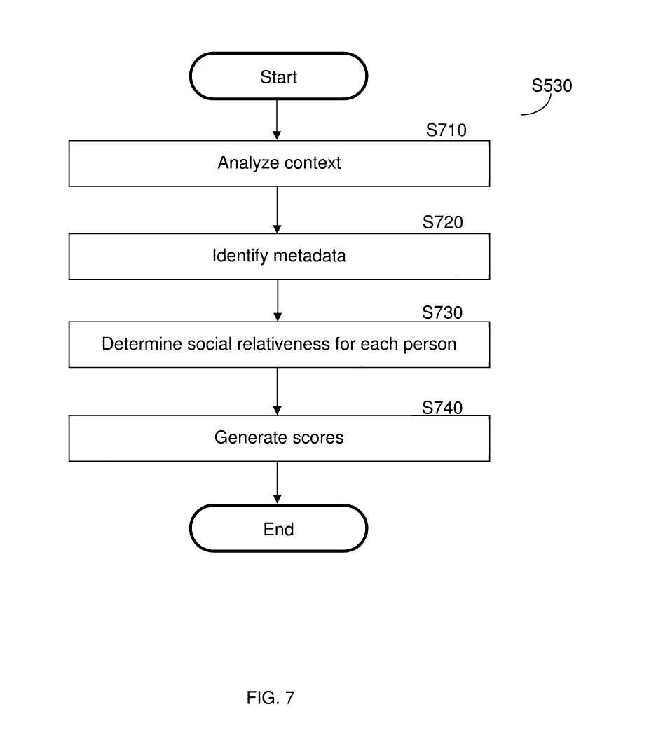

Based on the determined contexts, the associated metadata, or both, the server 140 is configured to generate a social linking score associated with each person depicted in the MMCEs. The social linking score is a value representing the social relativeness of two or more entities, where the social relativeness indicates how close the entities are within a social sphere. The entities may include, but are not limited to, people. As a non-limiting example, upon identifying a certain person as the user's son, the social linking score shall be higher than, for example, a colleague of the user. The generation of the social linking score is further described herein below with respect to FIG. 7.

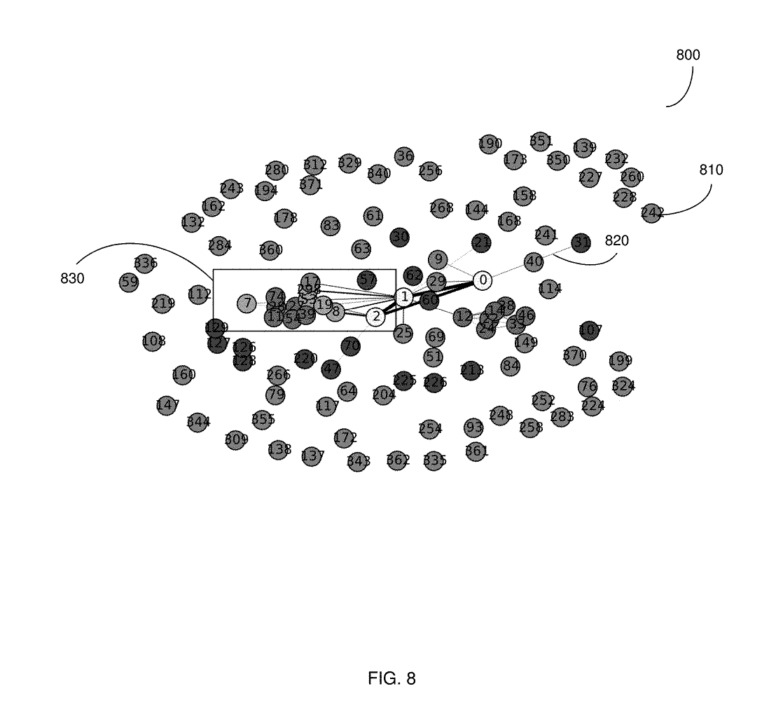

In an embodiment, based on the social linking scores, the server 140 is configured to generate a social linking graph representative of the persons shown in the MMCEs and their respective social linking scores. An example social linking graph is shown herein below in FIG. 8.

It should be noted that only one user device 120 and one application 125 are discussed with reference to FIG. 1 merely for the sake of simplicity. However, the embodiments disclosed herein are applicable to a plurality of user devices that can communicate with the server 130 via the network 110, where each user device includes at least one application.

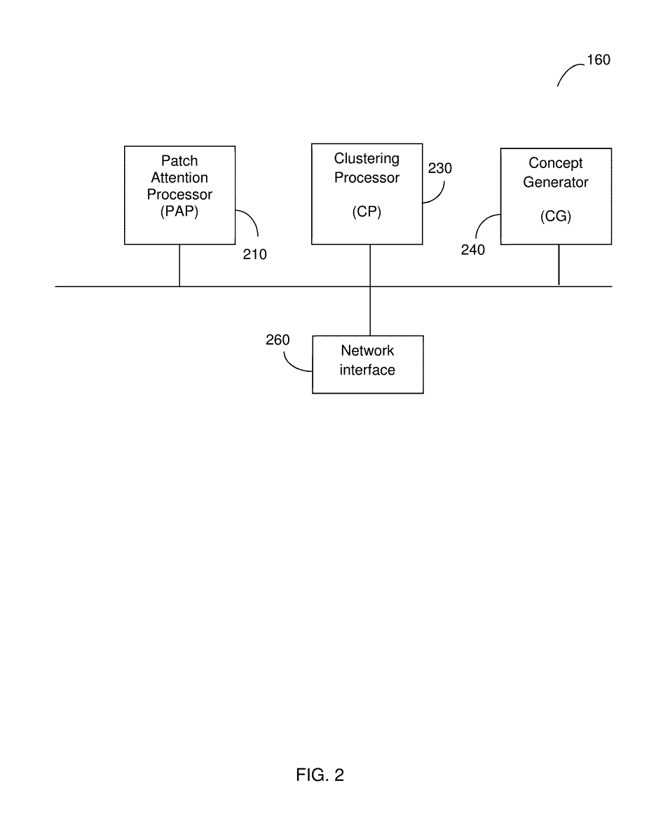

FIG. 2 shows an example diagram of a DCC system 160 for creating concepts. The DCC system 160 is configured to receive a first MMCE and at least a second MMCE, for example from the server 140 via a network interface 260.

The MMCEs are processed by a patch attention processor (PAP) 210, resulting in a plurality of patches that are of specific interest, or otherwise of higher interest than other patches. A more general pattern extraction, such as an attention processor (AP) (not shown) may also be used in lieu of patches. The AP receives the MMCE that is partitioned into items; an item may be an extracted pattern or a patch, or any other applicable partition depending on the type of the MMCE. The functions of the PAP 210 are described herein below in more detail.

The patches that are of higher interest are then used by a signature generator, e.g., the SGS 150 of FIG. 1, to generate signatures based on the patch. A clustering processor (CP) 230 inter-matches the generated signatures once it determines that there are a number of patches that are above a predefined threshold. The threshold may be defined to be large enough to enable proper and meaningful clustering. With a plurality of clusters, a process of clustering reduction takes place so as to extract the most useful data about the cluster and keep it at an optimal size to produce meaningful results. The process of cluster reduction is continuous. When new signatures are provided after the initial phase of the operation of the CP 230, the new signatures may be immediately checked against the reduced clusters to save on the operation of the CP 230. A more detailed description of the operation of the CP 230 is provided herein below.

A concept generator (CG) 240 is configured to create concept structures (hereinafter referred to as concepts) from the reduced clusters provided by the CP 230. Each concept comprises a plurality of metadata associated with the reduced clusters. The result is a compact representation of a concept that can now be easily compared against a MMCE to determine if the received MMCE matches a concept stored, for example, in the database 130 of FIG. 1. This can be done, for example and without limitation, by providing a query to the DCC system 160 for finding a match between a concept and a MMCE. In an embodiment, the DCC system 160 further includes an additional database (not shown) where concepts may be stored and retrieved for comparison.

It should be appreciated that the DCC system 160 can generate a number of concepts significantly smaller than the number of MMCEs. For example, if one billion (10⁹) MMCEs need to be checked for a match against another one billon MMCEs, typically the result is that no less than 10⁹×10⁹=10¹⁸ matches have to take place. The DCC system 160 would typically have around 10 million concepts or less, and therefore at most only 2×10⁶×10⁹=2×10¹⁵ comparisons need to take place, a mere 0.2% of the number of matches that have had to be made by other solutions. As the number of concepts grows significantly slower than the number of MMCEs, the advantages of the DCC system 160 would be apparent to one with ordinary skill in the art.

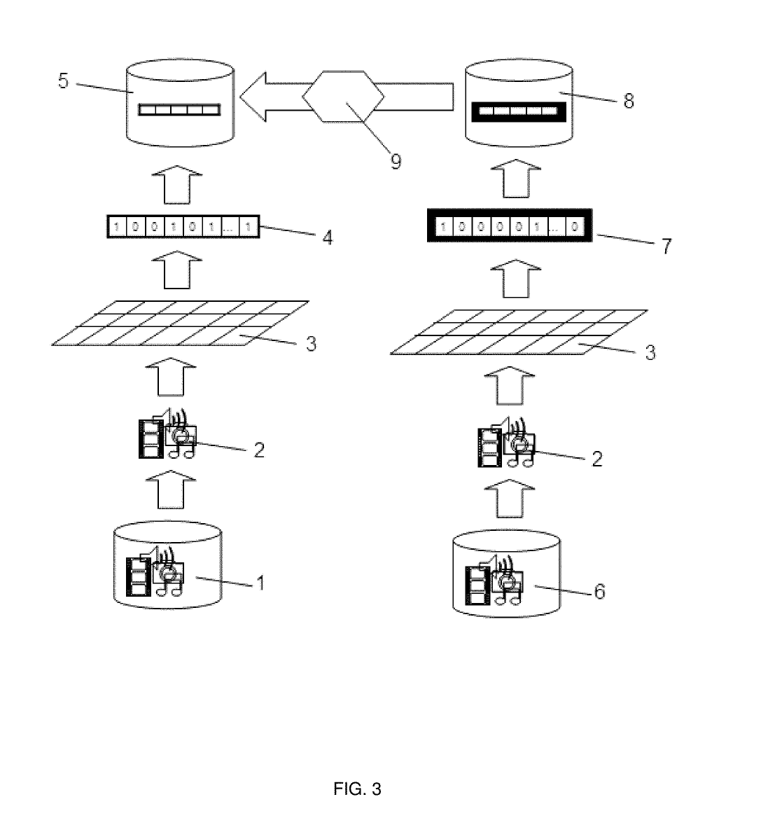

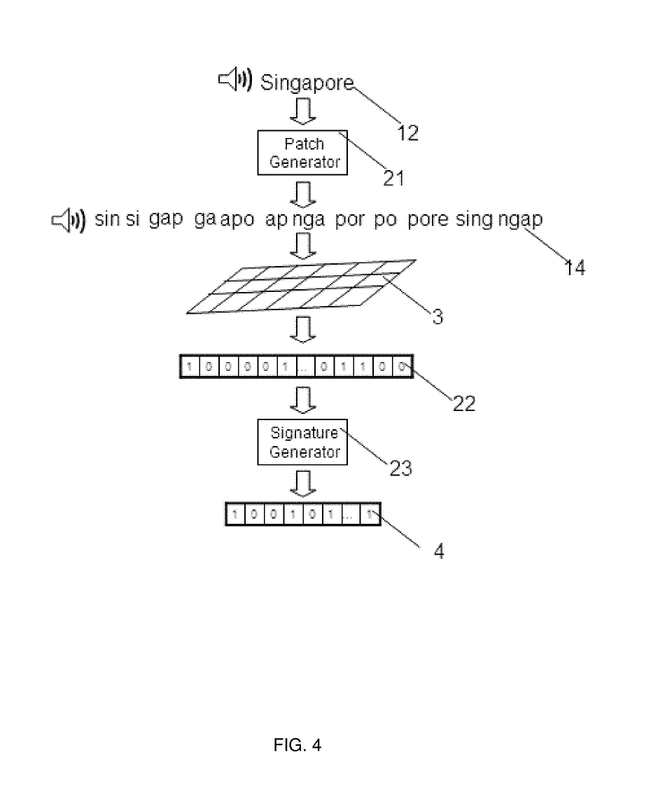

FIGS. 3 and 4 illustrate the generation of signatures for the multimedia content elements by the SGS 150 according to an embodiment. An example high-level description of the process for large scale matching is depicted in FIG. 3. In this example, the matching is for a video content.

Video content segments 2 from a Master database (DB) 6 and a Target DB 1 are processed in parallel by a large number of independent computational Cores 3 that constitute an architecture for generating the Signatures (hereinafter the “Architecture”). Further details on the computational Cores generation are provided below. The independent Cores 3 generate a database of Robust Signatures and Signatures 4 for Target content-segments 5 and a database of Robust Signatures and Signatures 7 for Master content-segments 8. An exemplary and non-limiting process of signature generation for an audio component is shown in detail in FIG. 4. Finally, Target Robust Signatures and/or Signatures are effectively matched, by a matching algorithm 9, to Master Robust Signatures and/or Signatures database to find all matches between the two databases.

To demonstrate an example of the signature generation process, it is assumed, merely for the sake of simplicity and without limitation on the generality of the disclosed embodiments, that the signatures are based on a single frame, leading to certain simplification of the computational cores generation. The Matching System is extensible for signatures generation capturing the dynamics in-between the frames. In an embodiment the server 130 is configured with a plurality of computational cores to perform matching between signatures.

The Signatures' generation process is now described with reference to FIG. 4. The first step in the process of signatures generation from a given speech-segment is to breakdown the speech-segment to K patches 14 of random length P and random position within the speech segment 12. The breakdown is performed by the patch generator component 21. The value of the number of patches K, random length P and random position parameters is determined based on optimization, considering the tradeoff between accuracy rate and the number of fast matches required in the flow process of the server 140 and SGS 150. Thereafter, all the K patches are injected in parallel into all computational Cores 3 to generate K response vectors 22, which are fed into a signature generator system 23 to produce a database of Robust Signatures and Signatures 4.

In order to generate Robust Signatures, i.e., Signatures that are robust to additive noise L (where L is an integer equal to or greater than 1) by the Computational Cores 3 a frame ‘i’ is injected into all the Cores 3. Then, Cores 3 generate two binary response vectors: \vec{S} which is a Signature vector, and \vec{RS} which is a Robust Signature vector.

For generation of signatures robust to additive noise, such as White-Gaussian-Noise, scratch, etc., but not robust to distortions, such as crop, shift and rotation, etc., a core Ci={nᵢ} (1≤i≤L) may consist of a single leaky integrate-to-threshold unit (LTU) node or more nodes. The node nᵢ equations are:

$${V}_{i} = {\sum }_{j} {w}_{ij} {k}_{j}$$

$${n}_{i} = θ ( {V}_{i} - {Th}_{x} )$$

where, θ is a Heaviside step function; wᵢⱼ is a coupling node unit (CNU) between node i and image component j (for example, grayscale value of a certain pixel j); kj is an image component ‘j’ (for example, grayscale value of a certain pixel j); Thₓ is a constant Threshold value, where ‘x’ is ‘S’ for Signature and ‘RS’ for Robust Signature; and Vi is a Coupling Node Value.

The Threshold values Thₓ are set differently for Signature generation and for Robust Signature generation. For example, for a certain distribution of Vᵢ values (for the set of nodes), the thresholds for Signature (Th_{S}) and Robust Signature (Th_{RS}) are set apart, after optimization, according to at least one or more of the following criteria:

1: For: Vᵢ>Th_{RS}

1−p(V>Th_{S})−1−(1−ε)¹<<1

i.e., given that l nodes (cores) constitute a Robust Signature of a certain image I, the probability that not all of these I nodes will belong to the Signature of same, but noisy image, Ĩ is sufficiently low (according to a system's specified accuracy).

2: p(Vᵢ>Th_{RS})=l/L

i.e., approximately l out of the total L nodes can be found to generate a Robust Signature according to the above definition.
3: Both Robust Signature and Signature are generated for certain frame i.

It should be understood that the generation of a signature is unidirectional, and typically yields lossless compression, where the characteristics of the compressed data are maintained but the uncompressed data cannot be reconstructed. Therefore, a signature can be used for the purpose of comparison to another signature without the need of comparison to the original data. The detailed description of the Signature generation can be found in U.S. Pat. No. 8,326,775, assigned to the common assignee, which is hereby incorporated by reference.

A Computational Core generation is a process of definition, selection, and tuning of the parameters of the cores for a certain realization in a specific system and application. The process is based on several design considerations, such as:

(a) The Cores should be designed so as to obtain maximal independence, i.e., the projection from a signal space should generate a maximal pair-wise distance between any two cores' projections into a high-dimensional space.

(b) The Cores should be optimally designed for the type of signals, i.e., the Cores should be maximally sensitive to the spatio-temporal structure of the injected signal, for example, and in particular, sensitive to local correlations in time and space. Thus, in some cases a core represents a dynamic system, such as in state space, phase space, edge of chaos, etc., which is uniquely used herein to exploit their maximal computational power.

(c) The Cores should be optimally designed with regard to invariance to a set of signal distortions, of interest in relevant applications.

A detailed description of the Computational Core generation and the process for configuring such cores is discussed in more detail in the U.S. Pat. No. 8,655,801 referenced above, the contents of which are incorporated by reference.

Signatures are generated by the Signature Generator System based on patches received either from the PAP 210, or retrieved from the database 130, as discussed herein above. It should be noted that other ways for generating signatures may also be used for the purpose the DCC system 160. Furthermore, as noted above, the array of computational cores may be used by the PAP 210 for the purpose of determining if a patch has an entropy level that is of interest for signature generation according to the principles of the invention.

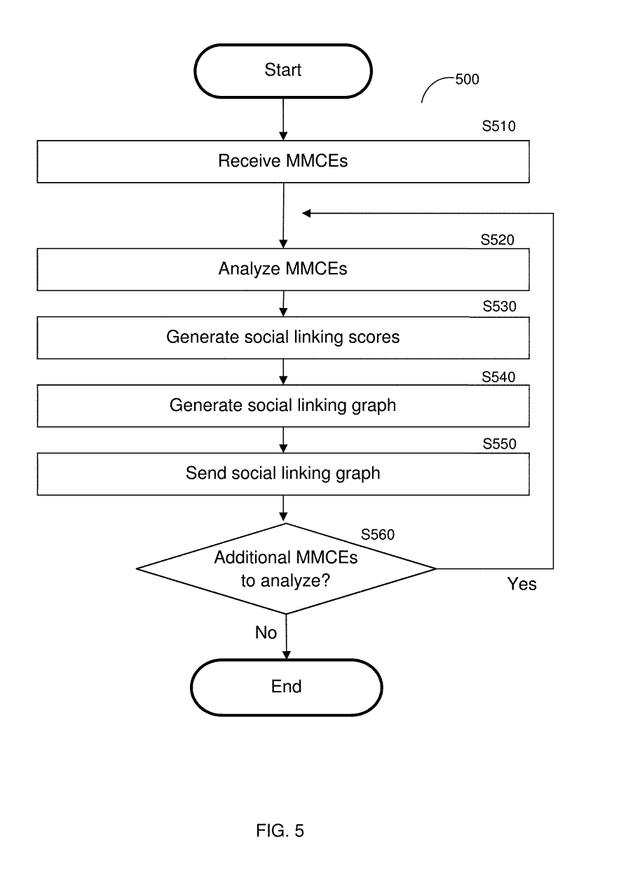

FIG. 5 illustrates a flowchart of a method 500 for generating social linking scores for persons shown in multimedia content elements according to an embodiment. In an embodiment, the method may be performed by the server 140, FIG. 1.

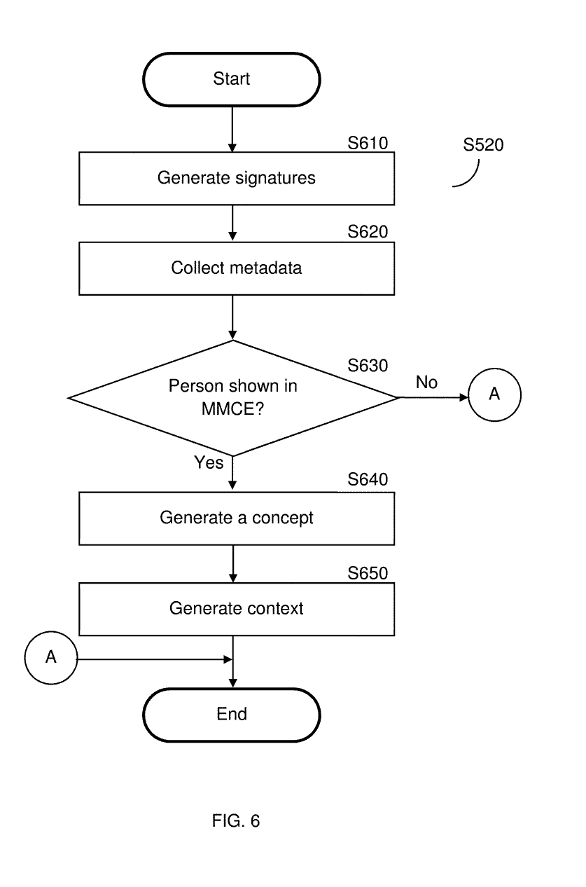

At S510, a plurality of MMCEs are received. At S520, the MMCEs are analyzed. In an embodiment, the analysis includes generating signatures, concepts, contexts, or a combination thereof, based on the received MMCEs as further described herein with respect to FIGS. 1 and 6.

At S530, a social linking score is generated for each person shown in the received MMCEs based on the analysis. Generating social linking scores is further described herein below with respect to FIG. 7.

At optional S540, a social linking graph is generated based on the generated social linking scores, where the social linking graph is a representation of the connections and relationship between persons identified within the received MMCEs. At optional S550, the social linking graph is sent to, for example, a user device (e.g., the user device 120, FIG. 1). At S560, it is checked whether additional MMCEs are to be analyzed and if so, execution continues with S520; otherwise, execution terminates.

FIG. 6 is a flowchart illustrating a method S520 of analyzing an MMCE according to an embodiment. At S610, at least one signature is generated for the MMCE, as described above with respect to FIG. 1, where signatures represent at least a portion of the MMCE. At S620, metadata associated with the MMCE is collected. The metadata may include, for example, a time stamp of the capturing of the MMCE, the device used for the capturing, a location pointer, tags or comments associated therewith, and the like.

At S630, based on the generated signatures and collected metadata, it is determined if at least one person is shown or depicted within the MMCE. If so, execution continues with S640; otherwise, execution terminates. In an embodiment, S630 includes comparing the generated signatures to reference signatures representing people, where it is determined that at least one person is shown when at least a portion of the generated signatures matches the reference signatures above a predetermined threshold.

At S640, when it is determined that a person is depicted in the MMCE, concepts are generated, where a concept is a collection of signatures representing elements of the unstructured data and metadata describing the concept. Each generated concept represents a person depicted in the MMCE. At S650, a context is generated based on correlation between the generated concepts. A context is determined as the correlation between a plurality of concepts.

FIG. 7 is a flowchart illustrating a method S530 of generating a social linking score in an embodiment. At S710, the generated context of each MMCE having a person shown therein is analyzed. At S720, metadata associated with the MMCEs is identified. At S730, based on the generated context and the identified metadata, the social relativeness between two or more persons shown in each MMCE and the user is determined. At S740, a social linking score is generated based on the social relativeness determination, and execution terminates. Each social linking score represents a closeness between two persons. For example, family members may have a higher social linking score than friends or acquaintances.

The generated social linking score may be based on, for example, an amount of multimedia content elements in which a person is shown, a time stamp associated with a first appearance in a multimedia content element, a time stamp associated with a last appearance in a multimedia content element, physical interaction with the user in the multimedia content elements (e.g., kissing, hugging, shaking hands, etc.), a location coordinate identified based on the analysis, other persons therein, tags and comments, a combination thereof, and the like.

In an embodiment, the social linking score may be determined based on weighted scoring. For example, if person A and person B only appear in one MMCE where they are kissing, while person A and person C appear in twenty MMCEs without physical contact, it may be determined that persons A and B are related or have a very close relationship, whereas persons A and C are not closely connected. Accordingly, the social linking score generated for persons A and B may be higher than the social linking score generated for persons B and C. In a further example, if persons A and D appear in an MMCE together where they are the only persons identified within the MMCE, and persons A and E appear together in large group picture, it may be determined that persons A and D have a closer relationship that persons A and E, and the social linking score generated for persons A and D may be higher than the social linking score generated for persons A and E.

FIG. 8 is an example diagram of a social linking graph 800 in an embodiment. The social linking graph 800 visually represents the social relativeness of each person shown in the MMCEs associated with the user of a user device, for example, the user device 120. Each circle 810 represents a person identified in the MMCEs. In an embodiment, lines 820 are shown extending between circles to represent connection between persons shown in the MMCEs. In some implementations, different colors, shading, line thickness, and other visual markers may be utilized to differentiate among individuals having higher social linking scores than individuals having lower social linking scores. A cluster 830 shows people having high (e.g., above a threshold) social linking scores with the user.

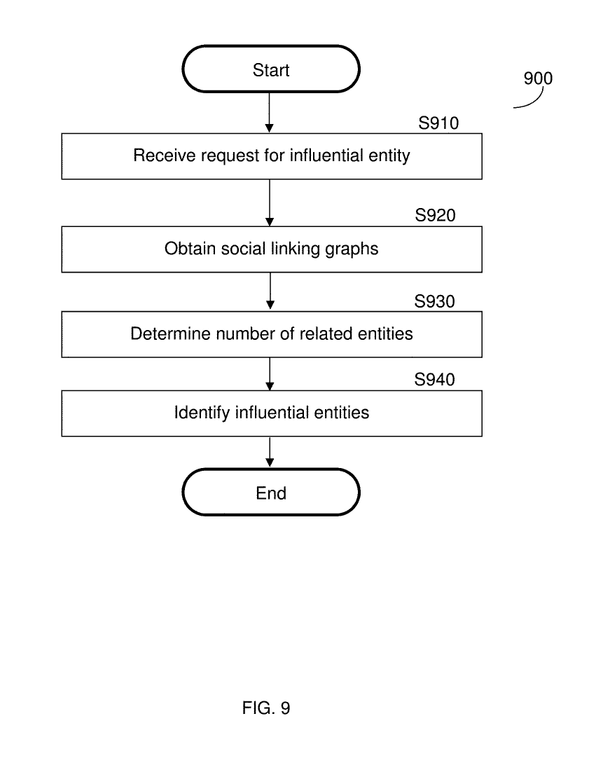

FIG. 9 is a flowchart illustrating a method of determining influential entities based on a social linking graph in an embodiment. At S910, a request to identify influential entities is received. In some implementations, the request may indicate one or more first required demographic parameters such as, for example, an age or range of ages; a gender; an occupation; a geographical location (e.g., location of residence); a marital status; an interest, identification or connection with respect to a particular idea or subject; and the like. As non-limiting examples for, the request may indicate an interest in sports, an identification of a particular brand, or a connection with a political view.

In some implementations, the required demographic parameters may be determined implicitly based on information included in the request. The determination may be based on one or more demographic determination rules. As a non-limiting example, when the request is for influential entities for selling wine, demographic parameters associated with alcoholic beverages including an age range of between 21-100 is determined.

At S920, social linking graphs of potential influential entities are obtained. In an embodiment, S920 includes querying a database (e.g., the database 130, FIG. 1) for the social linking graphs based on the required demographic parameters. The query results in the database returning social linking graphs of potential influential entities meeting the required demographic parameters. To this end, each entity indicated in the social linking graph may be associated with one or more second entity demographic parameters. The entity demographic parameters may be predetermined, or may be determined based on, for example, one or more social media profiles of each entity. A potential influential entity may meet the required demographic parameters when, for example, the entity demographic parameters match the required demographic parameters.

At S930, a number of related entities having a social linking score above a first score threshold is determined. The related entities are depicted within the social linking graph that are connected to a potential influential entity. For example, if a social linking score of 1 indicates a very strong connection to a potential influential entity, and a social linking score of 0.2 indicates a weak connection, the first predetermined threshold may require a social linking score above a 0.8. The number of related entities having social linking scores above 0.8 is determined from the social linking graph.

At S940, at least one influential entity is identified based on the determined numbers of related entities. In an embodiment, an entity may be determined to be an influential entity when the entity is connected to a number of related entities above a predetermined second number threshold. For example, an influential entity may be identified as an entity having at least 50 connections to related entities, where each related entity has a social linking score above a 0.8.

In a further embodiment, the number of other entities may only include entities meeting the required demographic parameters. As a non-limiting example, an entity may be an influential entity for required demographic parameters of men ages 20-22 when the entity has a social linking score of at least 0.7 with at least 200 entities having entity demographic parameters of “male” and ages “20,” “21,” or “22.”

As a non-limiting example for identifying influential entities, upon receiving a request to identify influential entities for promoting an online campaign for sport shoes, a required demographic parameter of “ages 19-45” associated with sports equipment is determined. A database is queried with respect to the determined age range for social linking graphs associated with potential influential entities Person A, Person B, and Person C, each having an age within the required age range. Based on the social linking graphs, the number of related entities having a social linking score above 0.8 and having an age between 19 and 45 is determined to be 500 for Person A, 50 for Person B, and 10 for Person C. Accordingly, Person A is identified as an influential entity.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input/output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for identifying influential entities depicted in multimedia content, comprising:
determining, for each of a plurality of social linking graphs, a number of related entities, wherein each related entity has a social linking score above a first predetermined threshold, wherein each social linking score is generated based on at least one context of at least one multimedia content element (MMCE), and wherein each context is determined based on signatures generated for the at least one MMCE;
identifying, based on the determined number of related entities, at least one influential entity, wherein each influential entity is associated with one of the social linking graphs for which the determined number of related entities is above a second predetermined threshold.

2. The method of claim 1, further comprising:
querying, based on at least one first demographic parameter, a database for the plurality of social linking graphs.

3. The method of 2, wherein each social linking graph is associated with a potential influential entity, wherein each potential influential entity is associated with at least one second demographic parameter matching the at least one first demographic parameter.

4. The method of claim 2, wherein each of the at least one first demographic parameter is at least one of: an age; a range of ages; a gender; an occupation; a geographical location; a marital status; an interest; an identification; and a connection.

5. The method of claim 1, wherein each context is determined by correlating between at least two concepts of the at least one MMCE.

6. The method of claim 5, wherein each concept is a collection of signatures and metadata describing the concept.

7. The method of claim 1, wherein each signature is generated by a signature generator system including a plurality of at least partially statistically independent computational cores, wherein the properties of each core are set independently of the properties of each other core.

8. The method of claim 1, wherein each signature is robust to noise and distortion.

9. A non-transitory computer readable medium having stored thereon instructions for causing a processing circuitry to perform a process, the process comprising:
determining, for each of a plurality of social linking graphs, a number of related entities, wherein each related entity has a social linking score above a first predetermined threshold, wherein each social linking score is generated based on at least one context of at least one multimedia content element (MMCE), and wherein each context is determined based on signatures generated for the at least one MMCE;
identifying, based on the determined number of related entities, at least one influential entity, wherein each influential entity is associated with one of the social linking graphs for which the determined number of related entities is above a second predetermined threshold.

10. A system for determining a social relativeness between at least two entities depicted in at least one multimedia content element (MMCE), comprising:
a processing circuitry; and
a memory, the memory containing instructions that, when executed by the processing circuitry, configure the system to:
determine, for each of a plurality of social linking graphs, a number of related entities, wherein each related entity has a social linking score above a first predetermined threshold, wherein each social linking score is generated based on at least one context of at least one multimedia content element (MMCE), and wherein each context is determined based on signatures generated for the at least one MMCE;
identify, based on the determined number of related entities, at least one influential entity, wherein each influential entity is associated with one of the social linking graphs for which the determined number of related entities is above a second predetermined threshold.

11. The system of claim 10, further comprising:
query, based on at least one first demographic parameter, a database for the plurality of social linking graphs.

12. The system of 11, wherein each social linking graph is associated with a potential influential entity, wherein each potential influential entity is associated with at least one second demographic parameter matching the at least one first demographic parameter.

13. The system of claim 11, wherein each of the at least one first demographic parameter is at least one of: an age; a range of ages; a gender; an occupation; a geographical location; a marital status; an interest; an identification; and a connection.

14. The method of claim 10, wherein each context is determined by correlating between at least two concepts of the at least one MMCE.

15. The system of claim 14, wherein each concept is a collection of signatures and metadata describing the concept.

16. The system of claim 10, wherein each signature is generated by a signature generator system including a plurality of at least partially statistically independent computational cores, wherein the properties of each core are set independently of the properties of each other core.

17. The system of claim 10, wherein each signature is robust to noise and distortion.
